(19) United States
(12) Patent Application Publication
(10) Pub. No.: US 2017/0249320 A1
(43) Pub. Date: Aug. 31, 2017

(54) COMPUTER-READABLE RECORDING MEDIUM, INFORMATION PROCESSING APPARATUS, AND INFORMATION PROCESSING METHOD

(71) Applicant: FUJITSU LIMITED, Kawasaki-shi (JP)

(72) Inventor: Takuya Makino, Kawasaki (JP)

(73) Assignee: FUJITSU LIMITED, Kawasaki-shi (JP)

(21) Appl. No.: 15/398,077

(22) Filed: Jan. 4, 2017

(30) Foreign Application Priority Data
Feb. 26, 2016 (JP) 2016-036283

(51) Int. Cl. G06F 17/30; G06F 17/27

(52) U.S. Cl. CPC G06F 17/3069; G06F 17/2785; G06F 17/30654; G06F 17/30707

(57) ABSTRACT

An information processing apparatus 1 groups, for each FAQ, past inquiries into resembling inquiries and non-resembling inquiries, computes, for each FAQ, the feature amounts of respective words for the corresponding FAQ that appear in the grouped resembling inquiries, converts, for each FAQ, by using the feature amounts of respective words for the corresponding FAQ, a word string to be extracted from the grouped resembling inquiries into a feature amount vector and converts a word string to be extracted from the grouped non-resembling inquiries to a feature amount vector, and updates, for each FAQ, a parameter vector that indicates importance degrees of the respective words for the FAQ on the basis of the feature amount vector of the word string extracted from the grouped resembling inquiries and the feature amount vector of the word string extracted from the grouped non-resembling inquiries.

### CROSS-REFERENCE TO RELATED APPLICATION(S)

This application is based upon and claims the benefit of priority of the prior Japanese Patent Application No. 2016-036283, filed on Feb. 26, 2016, the entire contents of which are incorporated herein by reference.

### FIELD

The embodiments discussed herein are related to a computer-readable recording medium, an information processing apparatus, and an information processing method.

### BACKGROUND

There is known a technology in which an already-answered question is searched for a newly-input question (for example, see non-Patent Literature 1). In the technology, first, an information processing apparatus collects, in a situation where a set of already-answered questions and answers thereof is given, pairs of questions in which the similarity between answers thereof is a preliminarily set threshold or more. As an example, in a case where the order is “r₁” when an answer “B” is searched by using an answer “A”, and the order is “r₂” when the answer “A” is searched by using the answer “B”, an information processing apparatus defines the similarity between the answers “A” and “B” by using the following formula (1).

$$sim ( A , B ) = \frac{1}{2} ( \frac{1}{{r}_{1}} + \frac{1}{{r}_{2}} ) \qquad ( 1 )$$

The information processing apparatus collects, as learning data, pairs of answers and questions of the answers, whose sim(A,B) are a preliminarily set threshold or more.

Next, the information processing apparatus learns semantic similarity between words using pairs of the collected questions by using unsupervised learning. As an example, in a case where the number of pairs of the questions is “N”, and a pair of i-th question thereamong is “Jⁱ”, the information processing apparatus calculates, by using the following formula (2), semantic relation probability between a word “t” and a word “s”, which appear in the pairs of the questions. Herein, “c(t|s; Jⁱ)” in the formula (2) is a degree in which the word “s” relates to the word “t” in the pair “Jⁱ”, and is calculated by using the following formula (3). Moreover, “cnt(t,Jⁱ)” in the formula (3) is a frequency of the word “t” in the pair “Jⁱ”, and “cnt(s,Jⁱ)” in the formula (3) is a frequency of the word “s” in the pair “Jⁱ”.

$$\begin{matrix}P ( t \vert s ) = {λ}_{s}^{- 1} {\sum }_{i = 1}^{N} c ( t \vert s ; {J}^{i} ) & ( 2 ) \\ c ( t \vert s ; {J}^{i} ) = \frac{P ( s \vert t )}{P ( t \vert {s}_{1} ) + … + P ( t \vert {s}_{n} )} cnt ( t , {J}^{i} ) cnt ( s , {J}^{i} ) & ( 3 )\end{matrix}$$

By employing this method, the value of a relation probability “P(t|s)” of the pair “Jⁱ” is higher as both the words “s” and “t” appear together in the pair “Jⁱ” more frequently.

Next, the information processing apparatus outputs, for a newly-input question, semantically resembling questions and answers thereof in a ranking type even in a case where words therebetween do not accord with each other. As an example, the information processing apparatus calculates a similarity “sim(Q,D)” between an input question “Q” and an already-answered question “D” by using the following formulae (4) and (5). “C” in the formula (5) is a set of questions. “P(w|D)” expresses the importance degree of a word “w”, which appears in the input question “Q”, in the already-answered question “D”. “T(w|t)” expresses the relation probability between the word “t” appeared in “D” and the word “w” appeared in “Q”. “Pₘₗ(t|D)” expresses the appearance probability of the word “t” in “D”. “Pₘₗ(w|C)” expresses the appearance probability of the word “w” in “C”.

$$\begin{matrix}sim ( Q , D ) \approx P ( Q \vert D ) = {\prod }_{w ∈ Q} P ( w \vert D ) & ( 4 ) \\ P ( w \vert D ) = ( 1 - λ ) {\sum }_{t ∈ D} ( T ( w \vert t ) {P}_{ml} ( t \vert D ) ) + λ {P}_{ml} ( w \vert C ) & ( 5 )\end{matrix}$$

By employing this method, the value of “sim(Q,D)” is higher as the word “w” appearing in the question “Q” appears more frequently in the already-answered question “D”, and as the relation degree to the word “t” that is important in the already-answered question “D” is higher.
Non-Patent Literature 1: Jiwoon Jeon, W. Bruce Croft, and Joon Ho Lee, “Finding Similar Questions in Large Question and Answer Archives”, CIKM'05

However, in the conventional technology, there is a problem in which an already-answered question for a newly-input question is not appropriately ranked in a case where words between the newly-input question and the already-answered question do not accord with each other. Namely, what is learned in the conventional technology is the relation probability between words, and is not whether or not the appearance of a word in a newly-input question is important for being associated with an already-answered question. In other words, the information processing apparatus calculates, by the second term of the formula (5), the appearance probability of the word “w”, which appears in the newly-input question “Q”, in a question set “C”, however, the word “w” is not always important for being associated with the already-answered question “D” because the appearance probability thereof is high. For example, in a case where “music” and “file” appear in the newly-input question “Q”, these words are not always important for associating the question “Q” with the question “D” because the words appear in the already-answered question “D”.

### SUMMARY

According to an aspect of an embodiment, a non-transitory computer-readable recording medium has stored therein an information processing program. The program causes a computer to execute a process. The process includes grouping a plurality of inquiry items into a resembling inquiry item group and a non-resembling inquiry item group. The process includes computing feature amounts of words that appear in the resembling inquiry item group. The process includes converting, by using the feature amounts of words, a first word string to be extracted from the resembling inquiry item group into a first feature amount vector and a second word string to be extracted from the non-resembling inquiry item group into a second feature amount vector. The process includes updating a parameter vector that indicates importance degrees of the words based on the first and second feature amount vectors.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of an information processing apparatus according to a first embodiment;

FIG. 2 is a diagram illustrating one example of the flow of a learning-data collecting process according to the first embodiment;

FIG. 3 is a diagram illustrating one example of the flow of a word feature-amount computing process according to the first embodiment;

FIG. 4 is a diagram illustrating one example of the flow of a word string feature-amount computing process according to the first embodiment;

FIGS. 5A to 5C are diagrams illustrating examples of the flow of a vocabulary importance computing process according to the first embodiment;

FIG. 6 is a diagram illustrating one example of the flow of a ranking outputting process according to the first embodiment;

FIG. 7 is a flowchart illustrating one example of information processing according to the first embodiment;

FIG. 8 is a functional block diagram illustrating a configuration of an information processing apparatus according to a second embodiment;

FIG. 9 is a diagram illustrating an outline of a ranking parameter learning process according to the second embodiment;

FIGS. 10A and 10B are diagrams illustrating examples of the flow of a ranking parameter learning process according to the second embodiment;

FIG. 11 is a diagram illustrating one example of the flow of a ranking outputting process according to the second embodiment;

FIG. 12 is a flowchart illustrating one example of information processing according to the second embodiment; and

FIG. 13 is a diagram illustrating one example of a computer that executes an information processing program.

### DESCRIPTION OF EMBODIMENTS

Preferred embodiments of the present invention will be explained with reference to accompanying drawings. In addition, the disclosed technology is not limited to the embodiments described below.

### [a] First Embodiment

### Configuration of Information Processing Apparatus According to First Embodiment

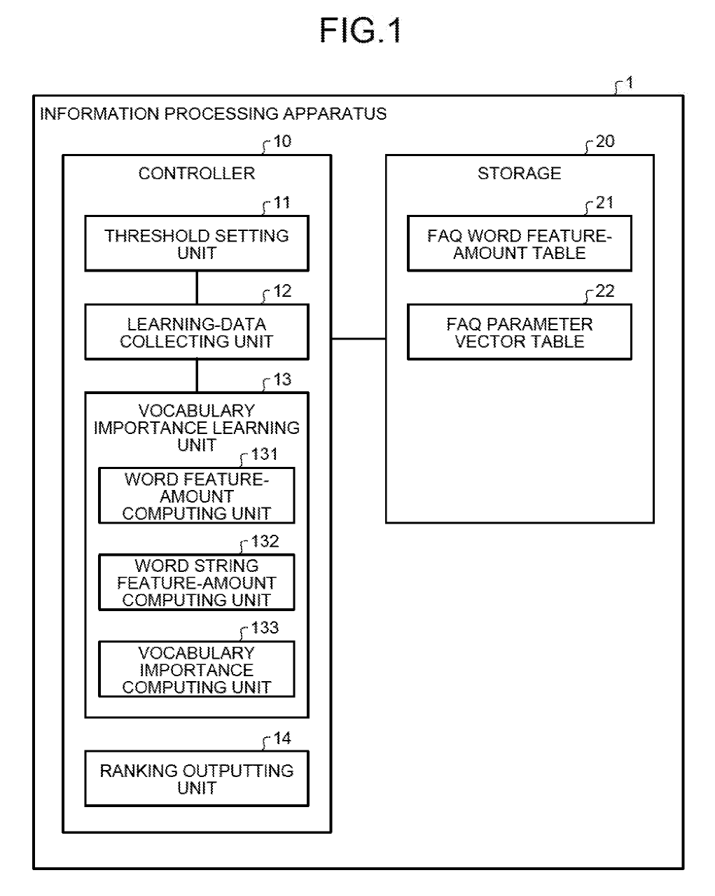

FIG. 1 is a functional block diagram illustrating a configuration of an information processing apparatus according to a first embodiment. An information processing apparatus 1 illustrated in FIG. 1 collects pairs of already-answered inquiries and Frequently Asked Questions (FAQs) on the basis of the similarity between answered parts of already-answered inquiries and FAQs. The information processing apparatus 1 acquires the importance degrees of words included in the pair for each FAQ by using the collected pairs as learning data. The aforementioned already-answered inquiry is an already-answered past question, and includes a semantically resembling question. One example of the already-answered inquiry includes a question in “Yahoo! chiebukuro”. The FAQ mentioned here is an already-answered past question, which does not semantically resembles another already-answered question, and an answer thereof. Hereinafter, the already-answered inquiry will be simply referred to as an “inquiry”.

The information processing apparatus 1 includes a controller 10 and a storage 20. The controller 10 corresponds to an electronic circuit such as a Central Processing Unit (CPU). The controller 10 includes a program that prescribes various processing procedures and an internal memory that stores controlling data to execute various processes thereby. The controller 10 includes a threshold setting unit 11, a learning-data collecting unit 12, a vocabulary importance learning unit 13, and a ranking outputting unit 14.

The storage 20 includes, for example, a semiconductor memory element such as a Random Access Memory (RAM) and a Flash Memory, and a storing device such as a hard disk and an optical disk. The storage 20 includes a FAQ word feature amount table 21 and a FAQ parameter vector table 22.

The FAQ word feature amount table 21 stores the feature amounts of words for each FAQ. The FAQ parameter vector table 22 stores a parameter vector for each FAQ. The parameter vector is a vectorized importance degree of vocabulary that includes words and word strings, and is generated for each FAQ. The FAQ word feature amount table 21 is generated by, for example, the vocabulary importance learning unit 13, and is used by the vocabulary importance learning unit 13 and the ranking outputting unit 14. The FAQ parameter vector table 22 is generated by, for example, the vocabulary importance learning unit 13, and is used by the ranking outputting unit 14.

The threshold setting unit 11 sets, in the storage 20, a threshold that is used in collecting the learning data. For example, the threshold setting unit 11 receives a threshold that is input by a user, and sets the received threshold in the storage 20.

The learning-data collecting unit 12 calculates a concordance rate of words between an answered part in a FAQ and an answered part in an inquiry history, and acquires the order. The learning-data collecting unit 12 collects pairs of answered parts of the FAQs in which scores based on the order are the threshold or more, and FAQs and inquiries, which correspond to answered parts of the inquiry history. The collection of the learning data of the learning-data collecting unit 12 may be executed by, for example, ‘Jiwoon Jeon, W. Bruce Croft, and Joon Ho Lee, “Finding Similar Questions in Large Question and Answer Archives”, CIKM'05’.

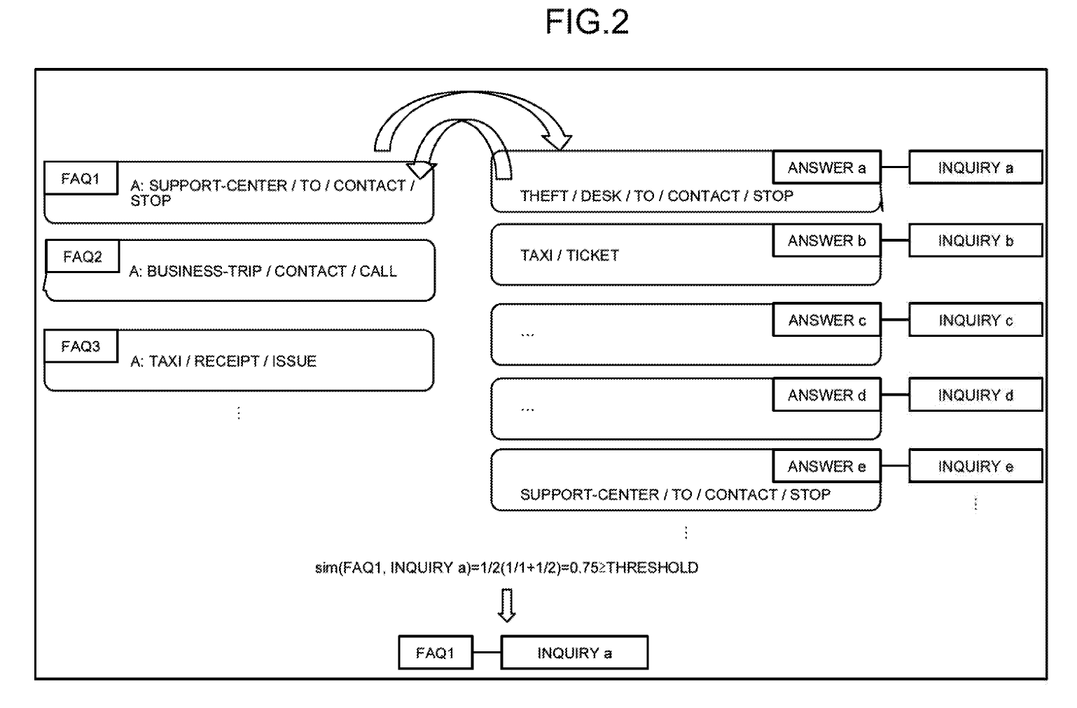

Herein, one example of the flow of a learning-data collecting process according to the first embodiment will be explained with reference to FIG. 2. FIG. 2 is a diagram illustrating one example of the flow of a learning-data collecting process according to the first embodiment. In FIG. 2, the inquiry history is illustrated, which includes a plurality of FAQs and a plurality of inquiries and answers.

In such a situation, the learning-data collecting unit 12 calculates an order in a case where an answer of an inquiry is searched by using an answer of a FAQ, and an order in a case where the answer of the FAQ is searched by using the answer of the inquiry. For example, it is assumed that the order is second place in a case where an answer “a” of an inquiry “a” is searched by using an answer of a FAQ1, and the order is first place in a case where the answer of the FAQ1 is searched by using the answer “a” of the inquiry “a”.

The learning-data collecting unit 12 computes the similarity between the answer of the FAQ1 and the answer “a” of the inquiry “a” by using the formula (1). Herein, the similarity “sim” between the FAQ1 and the inquiry “a” is computed to be “0.75” by using the formula (1) to be determined that the computed result is the threshold or more. Subsequently, the learning-data collecting unit 12 acquires the answered part of the FAQ1 and the answered part of the inquiry history, whose similarity is the threshold or more, and collects the FAQ1 and the inquiry “a” corresponding thereto.

The collection of the FAQ1 and the inquiry “a” has been explained, the learning-data collecting unit 12 continuously collects FAQs and inquiries, whose similarity is the threshold or more.

The vocabulary importance learning unit 13 learns, for each FAQ, the importance degree of vocabulary that includes words and word strings. The vocabulary importance learning unit 13 includes a word feature-amount computing unit 131, a word string feature-amount computing unit 132, and a vocabulary importance computing unit 133.

The word feature-amount computing unit 131 computes the feature amount of a word for each FAQ.

For example, the word feature-amount computing unit 131 executes word-division to the inquiries collected by the learning-data collecting unit 12 to convert into word strings of noun, verb, etc. As an example, the inquiry is assumed to be “reissue of X card, go on a business-trip from now, however, the card is not found . . . ”. The word feature-amount computing unit 131 executes word-division to the inquiry to acquire “X card”, “reissue”, “business-trip”, and “found”, and converts the inquiry to a word string “X card, reissue, business-trip, found”.

The word feature-amount computing unit 131 groups, for each FAQ, inquiries to be paired with the FAQ from the pairs of the FAQs and the inquiries, which are collected by the learning-data collecting unit 12.

The word feature-amount computing unit 131 computes the feature amounts of words for each FAQ by using the following formula (7), and stores the amounts in the FAQ word feature amount table 21. The formula (7) uses the computed result of the following formula (6).

$$score ( w ; {FAQ}_{i} ) = log \frac{{p}_{{FAQ}_{i}} ( w )}{{\sum }_{k} {p}_{{FAQ}_{k}} ( w )} \qquad ( 7 )$$

As an example, the word feature-amount computing unit 131 computes, by using the formula (6), the appearance probability of the word “w” in a set “Ci” of the inquiry that is paired with a FAQi. Herein, “i” indicates the number to identify a FAQ, “w” indicates a word included in the set “Ci”, and “cnt(w,Ci)” is a function that acquires the appearance count of the word “w” in the set “Ci”. For example, in a case where “w” is “reissue”, the appearance count of “reissue” in the set “Ci” is acquired.

$${p}_{FAQ} ( w ) = \frac{cnt ( w , {C}_{i} )}{{\sum }_{k} cnt ( {w}_{k} , {C}_{i} )} \qquad ( 6 )$$

The word feature-amount computing unit 131 computes the relative importance degree (feature amount) of the word “w” in the FAQi by using the formula (7). A score(w; FAQi) is the relative importance degree of the word “w” in the FAQi. By the formulae (6) and (7), the score (score(w; FAQi)) is higher as the word “w” relatively appears more frequently in the FAQi than in another FAQ. For example, it is found that more information exists (score is higher) in a case where the word “reissue” appears once in “C1” whose total appearance count of words is “10” than in a case where the word “reissue” appears twice in {C1, C2, C3} whose total appearance count of words is “100”.

The word string feature-amount computing unit 132 computes the feature amounts of word strings for each FAQ. For example, the word string feature-amount computing unit 132 computes the feature amounts of word strings in inquiries for each FAQ by using the following formula (8), and stores the amounts in the FAQ word feature amount table 21. In other words, the word string feature-amount computing unit 132 computes the feature amount of a word string, which indicates whether or not an inquiry is a word string having characteristics of the FAQ. The formula (8) uses the computed results of the following formulae (9) and (10).

As an example, the word string feature-amount computing unit 132 is assumed to compute the feature amount of whole of the word string of the inquiry “a” in the FAQ1. The word string feature-amount computing unit 132 computes, by using the following formula (8), a score that indicates the amount of characteristics of the FAQ1 for a word string of the inquiry “a”.

$${score}_{{FAQ}_{i}} ( a ) = {\sum }_{i}^{\vert a \vert} p ( {w}_{i} ) log \frac{p ( {w}_{i} )}{q ( {w}_{i} )} \qquad ( 8 )$$

Herein, “p(wi)” in the formula (8) is computed by the formula (9), and “p(wi)” indicates the probability that a word “wi” appears in the word string “a” in terms of the FAQ1.

$$p ( {w}_{i} ) = \frac{score ( {w}_{i} ; {FAQ}_{1} )}{{\sum }_{k} score ( {w}_{k} ; {FAQ}_{1} )} \qquad ( 9 )$$

Herein, “q(wi)” in the formula (8) is computed by the formula (10), and “q(wi)” indicates the probability that the word “wi” appears in the word string “a” without consideration of a FAQ.

$$q ( {w}_{1} ) = \frac{{\sum }_{m} score ( {w}_{1} ; {FAQ}_{m} )}{{\sum }_{m} {\sum }_{k} score ( {w}_{k} ; {FAQ}_{m} )} \qquad ( 10 )$$

By the formula (8), the feature amount of whole of the word string of the inquiry “a” in the FAQ1 is higher as the probability of appearance in the FAQ1 of each word “w” in a word string of the inquiry “a” is larger compared with another FAQ. In other words, the score that indicates the amount of characteristics of the FAQ1 is higher in a word string in which the word “reissue” with other words appear than in a word string in which the word “reissue” appears by chance.

The vocabulary importance computing unit 133 computes, for each FAQ, the importance degree of the vocabulary that includes words and word strings.

For example, the vocabulary importance computing unit 133 groups, from the pairs of the FAQs and the inquiries that are collected by the learning-data collecting unit 12, word strings of the inquiries to be paired with a FAQ and word strings of the inquiries not to be paired with a FAQ, for each FAQ. The vocabulary importance computing unit 133 converts a word string to be paired with a FAQ into a feature amount vector for each FAQ by using the feature amount of a word in the FAQ word feature amount table 21, which corresponds to the FAQ. The vocabulary importance computing unit 133 adds the feature amount of a word string to a feature amount vector converted with respect to the word string. The vocabulary importance computing unit 133 converts a word string not to be paired with a FAQ to a feature amount vector for each FAQ by using the feature amount of the word in the FAQ word feature amount table 21, which corresponds to the FAQ. The vocabulary importance computing unit 133 adds the feature amount of the word string to the feature amount vector converted with respect to the word string. The feature amount vector mentioned here includes columns whose number is the total of one corresponding to a word string and the number of all of the words included in an inquiry history, and the columns are assigned to setting of the respective feature amounts of words and word strings. As an example, the first column is assigned to setting of the feature amount of “X card”. The second column is assigned to setting of the feature amount of “reissue”.

The vocabulary importance computing unit 133 computes a parameter vector (importance degree of vocabulary) for each FAQ by using a feature amount vector to which a word string of an inquiry is converted. As an example, the vocabulary importance computing unit 133 is assumed to compute a parameter vector of the FAQ1. In a case of a word string of an inquiry to be paired with the FAQ1, the vocabulary importance computing unit 133 updates a parameter vector of the FAQ1 so that the weight of the feature amount that appears in the word string is large in the positive direction. Moreover, in a case of a word string of an inquiry not to be paired with the FAQ1, the vocabulary importance computing unit 133 updates a parameter vector of the FAQ1 so that the weight of the feature amount that appears in a word string is large in the negative direction. The vocabulary importance computing unit 133 stores the parameter vector calculated for each FAQ in the FAQ parameter vector table 22. The parameter vector mentioned here is a vector that indicates the degree of importance of a word assigned to each column for a FAQ, and is computed for each FAQ. Thereby, the vocabulary importance computing unit 133 refers to a parameter vector of a FAQ, so that it is possible to specify the vocabulary that is important for the FAQ.

The ranking outputting unit 14 ranks and outputs FAQs, for a new inquiry, by using parameter vectors learned for respective FAQs by the vocabulary importance learning unit 13. For example, the ranking outputting unit 14 converts a word string of a new inquiry to a feature amount vector of each FAQ by using the feature amounts of words in the FAQ word feature amount table 21, which correspond to the corresponding FAQ. The ranking outputting unit 14 computes, for each FAQ, the inner product of the converted feature amount vector and the parameter vector stored in the FAQ parameter vector table 22. The value of the computed inner product may be a value that indicates the amount of characteristics of the FAQ, which is included in a new inquiry. The ranking outputting unit 14 sorts values of the computed inner products in descending order, and ranks and outputs FAQs.

Flow of Word Feature-Amount Computing Process

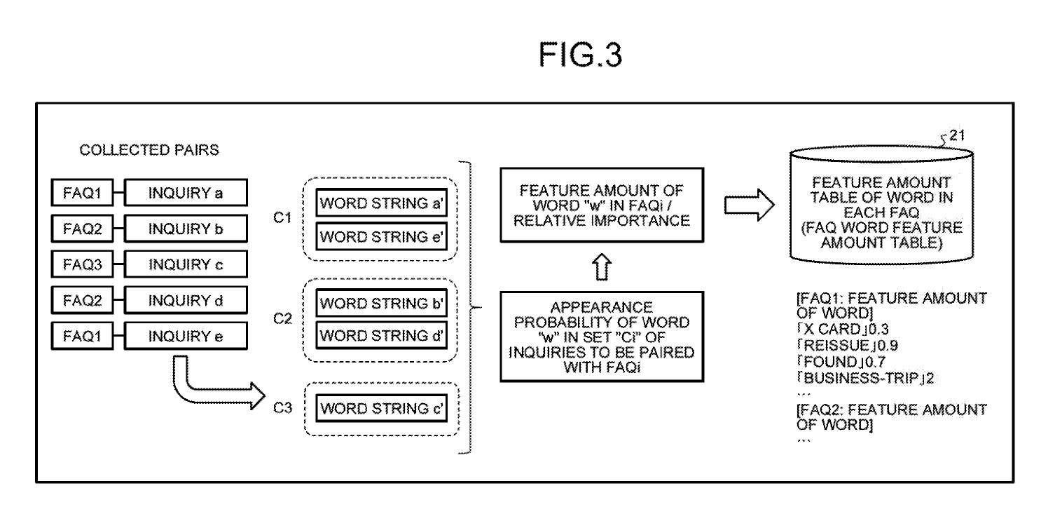

FIG. 3 is a diagram illustrating one example of the flow of a word feature-amount computing process according to the first embodiment. In FIG. 3, pairs of FAQs and inquiries are illustrated, which are collected by the learning-data collecting unit 12. Herein, a pair of the FAQ1 and the inquiry “a”, a pair of a FAQ2 and an inquiry “b”, a pair of a FAQ3 and an inquiry “c”, a pair of the FAQ2 and an inquiry “d”, and a pair of the FAQ1 and an inquiry “e” are illustrated.

In such a situation, the word feature-amount computing unit 131 groups, from the collected pairs of the FAQs and inquiries, inquiries to be paired with a FAQ, for each FAQ. Herein, an inquiry set “C1” to be paired with the FAQ1 is {word string “a′” of inquiry “a”, word string “e′” of inquiry “e”}. An inquiry set “C2” to be paired with the FAQ2 is {word string “b′” of inquiry “b”, word string “d′” of inquiry “d”}. An inquiry set “C3” to be paired with the FAQ3 is {word string “c′” of inquiry “c”}.

The word feature-amount computing unit 131 computes, for a FAQi, the appearance probability of the word “w” in an set “Ci” of inquiries to be paired with the FAQi by using the formula (6). The word feature-amount computing unit 131 computes the relative importance degree (feature amount) in the FAQi of the word “w” by using the formula (7). The word feature-amount computing unit 131 stores in the FAQ word feature amount table 21 the computed feature amount of the word “w” of the FAQi. Herein, for example, with respect to the FAQ1, “0.3” as the feature amount of “X card”, “0.9” as the feature amount of the word “reissue”, “2” as the feature amount of the word “business-trip”, “0.7” as the feature amount of the word “found”, etc. are stored in the FAQ word feature amount table 21.

Flow of Word String Feature-Amount Computing Process

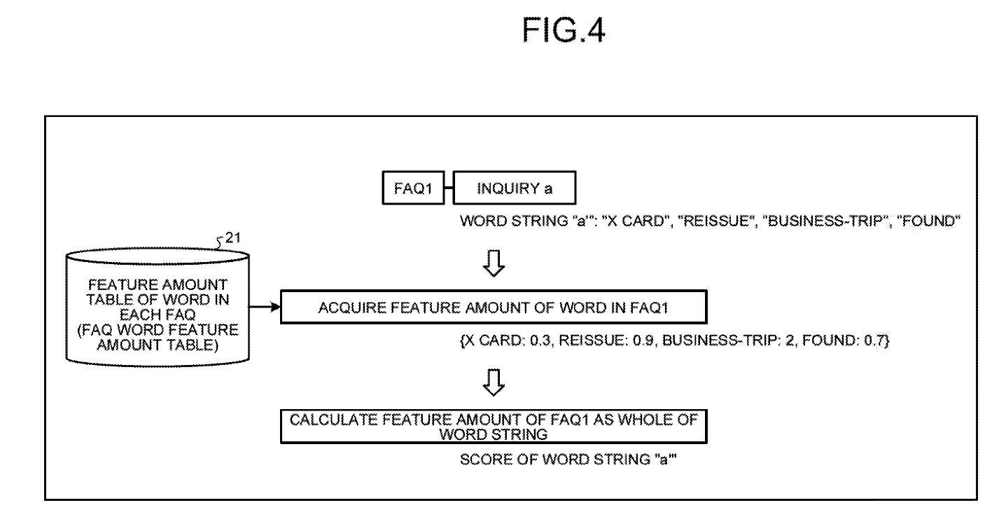

FIG. 4 is a diagram illustrating one example of the flow of a word string feature-amount computing process according to the first embodiment. As illustrated in FIG. 4, the feature amount of the word string “a′” of the inquiry “a” in the FAQ1 is assumed to be computed for the pair of the FAQ1 and the inquiry “a”. The word string “a′” of the inquiry “a” is assumed to be “X card”, “reissue”, “business-trip”, and “found”.

In such a situation, the word string feature-amount computing unit 132 acquires, from the FAQ word feature amount table 21, the feature amount of a word in the FAQ1 for each word included in the word string “a′”. Herein, “0.3” as “X card”, “0.9” as “reissue”, “2” as “business-trip”, and “0.7” as “found” are acquired.

The word string feature-amount computing unit 132 calculates the feature amount of the FAQ1 as whole of the word string “a′” of the inquiry “a” by using the formula (8). In other words, the word string feature-amount computing unit 132 indicates whether or not the inquiry “a” is the word string “a′” that has characteristics of the FAQ1 by using the feature amount of the word string “a′”. Herein, the score (feature amount) of the FAQ1 as whole of the word string “a′” is calculated to be “0.9”.

Thereby, the feature amount of whole of the word string “a′” of the inquiry “a” in the FAQ1 is higher as the probability of appearance in the FAQ1 of each word “w” in the word string “a′” of the inquiry “a” is larger compared with another FAQ. In other words, the score that indicates the amount of characteristics of the FAQ1 is higher in a word string in which the word “reissue” with other words appear than in a word string in which the word “reissue” appears by chance. For example, in the FAQ1, the score is higher in the word string “a′” of “X card, reissue, business-trip, found” in which the word “reissue” with other words appear than in a word string of “reissue, receipt, taxi” in which “reissue” appears by chance.

Processing Procedure for Vocabulary Importance Computing

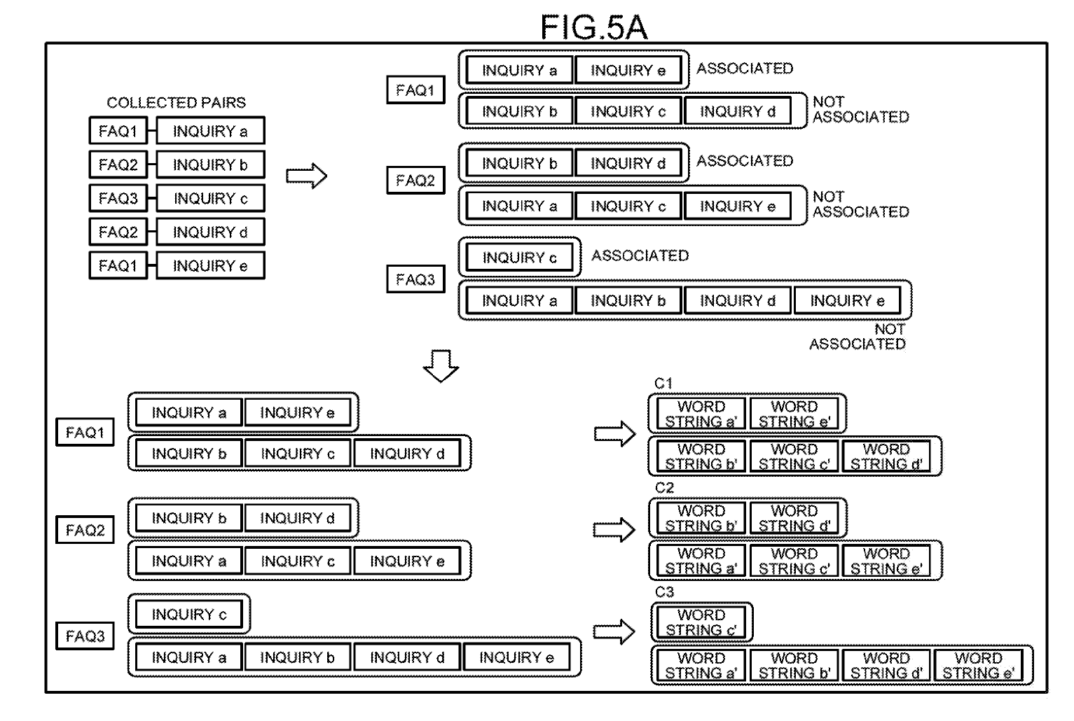

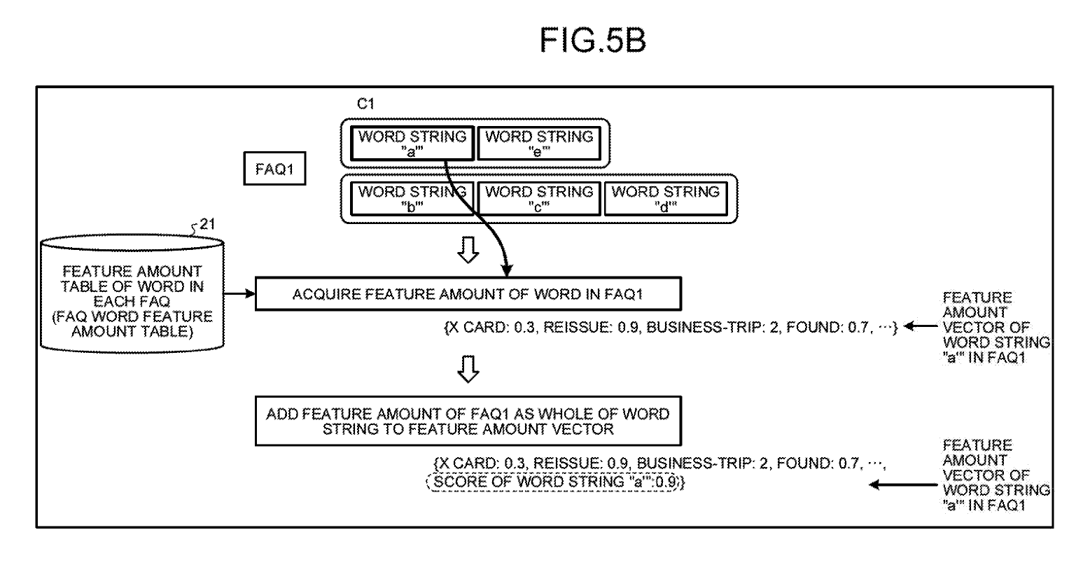

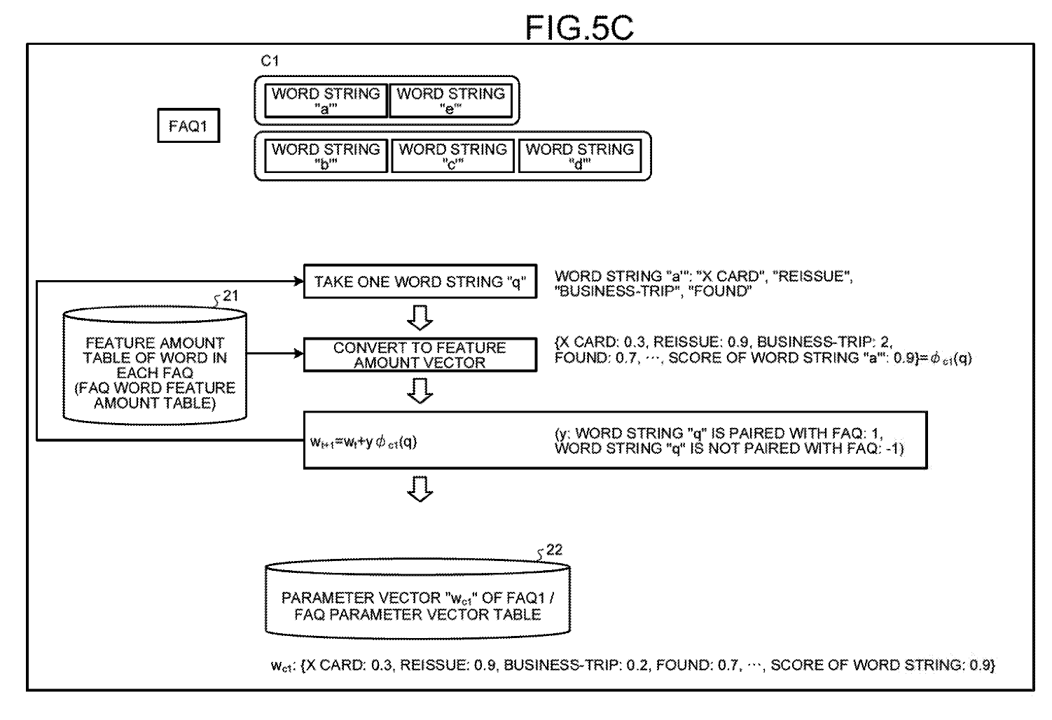

FIGS. 5A to 5C are diagrams illustrating examples of the flows of a vocabulary importance computing process according to the first embodiment. In FIG. 5A, pairs of FAQs and inquiries are illustrated, which are collected by the learning-data collecting unit 12. The collected pairs are the same as those illustrated in FIG. 3.

In such a situation, the vocabulary importance computing unit 133 respectively groups, from the pairs of the FAQs and the inquiries that are collected by the learning-data collecting unit 12, the inquiries to be paired with a FAQ and the inquiries not to be paired with a FAQ, for each FAQ. Herein, as an example, the inquiries to be paired (associated) with the FAQ1 are {inquiry “a”, inquiry “e”}, and the inquiries not to be paired (not associated) with the FAQ1 are {inquiry “b”, inquiry “c”, inquiry “d”}. The inquiries to be paired (associated) with the FAQ2 are {inquiry “b”, inquiry “d”}, and the inquiries not to be paired (not associated) with the FAQ2 are {inquiry “a”, inquiry “c”, inquiry “e”}.

The vocabulary importance computing unit 133 executes word-division and converts inquiries into word strings. Herein, the set “C1” of the word strings of the inquiries to be paired (associated) with the FAQ1 is {word string “a′”, word string “e′”}, and the set of the word strings of the inquiries to be paired (not associated) with the FAQ1 is {word string “b′”, word string “c′”, word string “d′”}. The set “C2” of the word strings of the inquiries to be paired (associated) with the FAQ2 is {word string “b′”, word string “d′”}, and the set of the word strings of the inquiries to be paired (not associated) with the FAQ2 is {word string “a′”, word string “c′”, word string “e′”}.

As illustrated in FIG. 5B, the vocabulary importance computing unit 133 converts, for each FAQ, the word strings to be pared with a FAQ and the word strings not to be paired with a FAQ into respective feature amount vectors by using the feature amounts of words in the FAQ word feature amount table 21, which correspond to the FAQ. Herein, a case in which the word string “a′” to be paired with the FAQ1 is converted into a feature amount vector will be explained. The word string “a′” is assumed to be “X card, reissue, business-trip, found”.

The vocabulary importance computing unit 133 acquires the feature amount of the word in the FAQ1 from the FAQ word feature amount table 21 for each word included in the word string “a′”. The vocabulary importance computing unit 133 converts the word string “a′” into a feature amount vector in the FAQ1. Herein, {X card: 0.3, reissue: 0.9, business-trip: 2, found: 0.7, etc.} is a feature amount vector of the word string “a′” in the FAQ1.

The vocabulary importance computing unit 133 acquires the feature amount for the word string “a′” in the FAQ1 from the FAQ word feature amount table 21. The vocabulary importance computing unit 133 adds the feature amount of the word string “a′” to the feature amount vector converted with respect to the word string “a′”. As a result, {X card: 0.3, reissue: 0.9, business-trip: 2, found: 0.7, . . . , score for word string “a′”: 0.9} becomes a feature amount vector of the word string “a′” in the FAQ1.

As illustrated in FIG. 5C, the vocabulary importance computing unit 133 computes, for each FAQ, a parameter vector (importance degree of vocabulary) by using the converted feature amount vector. Herein, a case in which a parameter vector “w_{c1}” of the FAQ1 is computed will be explained. The set “C1” of the word strings of the inquiries to be paired (associated) with the FAQ1 and the set of the word strings of the inquiries not to be paired (not associated) with the FAQ1 are the same as those illustrated in FIG. 5B.

The vocabulary importance computing unit 133 takes one word string “q” from the word string group of the FAQ1. Herein, the word string “a′” is assumed to be taken. The word string “a′” is assumed to be “X card, reissue, business-trip, found”.

The vocabulary importance computing unit 133 converts the word string “q” into a feature amount vector “φ_{c1}(q)”. The process in which the word string is converted to the feature amount vector is similar to the process having explained in FIG. 5B, and thus, explanation thereof will be omitted. Herein, the feature amount vector “φ_{c1}(q)” of the word string “a′” in the FAQ1 is {X card: 0.3, reissue: 0.9, business-trip: 2, found: 0.7, score for word string “a′”: 0.9}.

The vocabulary importance computing unit 133 updates the parameter vector “w_{c1}” of the FAQ1 on the basis of the following formula (11). Herein, the initial value of “wₜ” in the formula (11) is zero. In a case where the word string “q” is paired with a FAQ, “y” is “1”, and in a case where the word string “q” is not paired with a FAQ, “y” is “−1”.

wₜ₊₁=wₜ+yφ_{c1}(q) (11)

In other words, the vocabulary importance computing unit 133 updates the parameter vector “w_{c1}” of the FAQ1 so that the weight of the feature amount that appears in the word string to be paired with the FAQ1 is large in the positive direction. On the other hand, the vocabulary importance computing unit 133 updates the parameter vector “w_{c1}” of the FAQ1 so that the weight of the feature amount that appears in the word string not to be paired with the FAQ1 is large in the negative direction. The update width of the weight of the feature amount differs in accordance with the value of the feature amount. For example, “reissue” and “X card” appear in the word string “a′” paired with the FAQ′, the feature amount of “reissue” is “0.9” and the feature amount of “X card” is “0.3”, and thus, the weight of the feature amount of “reissue” is updated more widely in the positive direction than the weight of the feature amount of “X card”. In other words, the update width of the weight of the feature amount in “reissue” is larger than that of “X card”.

The vocabulary importance computing unit 133 takes the word string “q” one by one until the word string “q” that is not taken from the word string group of the FAQ′ is zero, converts the word string “q” into the feature amount vector, and repeats to divide, caused by whether or not the word string “q” is paired with the FAQ′, the update of the weight of the feature amount between the positive and the negative. The vocabulary importance computing unit 133 acquires the parameter vector “w_{c1}” of the FAQ′. Herein, the parameter vector “w_{c1}” of the FAQ′ is {X card: 0.3, reissue: 0.9, business-trip: 0.2, found: 0.7, score for word string: 0.9}.

Thereby, for example, in a case where “reissue” frequently appears not only in the inquiry paired with the FAQ1 but also in the inquiry not paired with the FAQ′, because the feature amount of the FAQ1 is large, the correlation with the FAQ1 is estimated to be high, however, the importance degree for the FAQ1 is low. In other words, “reissue” can be determined not to have a certain amount of characteristics of the FAQ1. On the other hand, in a case where “reissue” appears in the inquiry paired with the FAQ1 and does not appear in the inquiry not paired with the FAQ1, the importance degree for the FAQ1 is high. In other words, “reissue” can be determined to have a certain amount of characteristics of the FAQ1.

Flow of Ranking Outputting Process

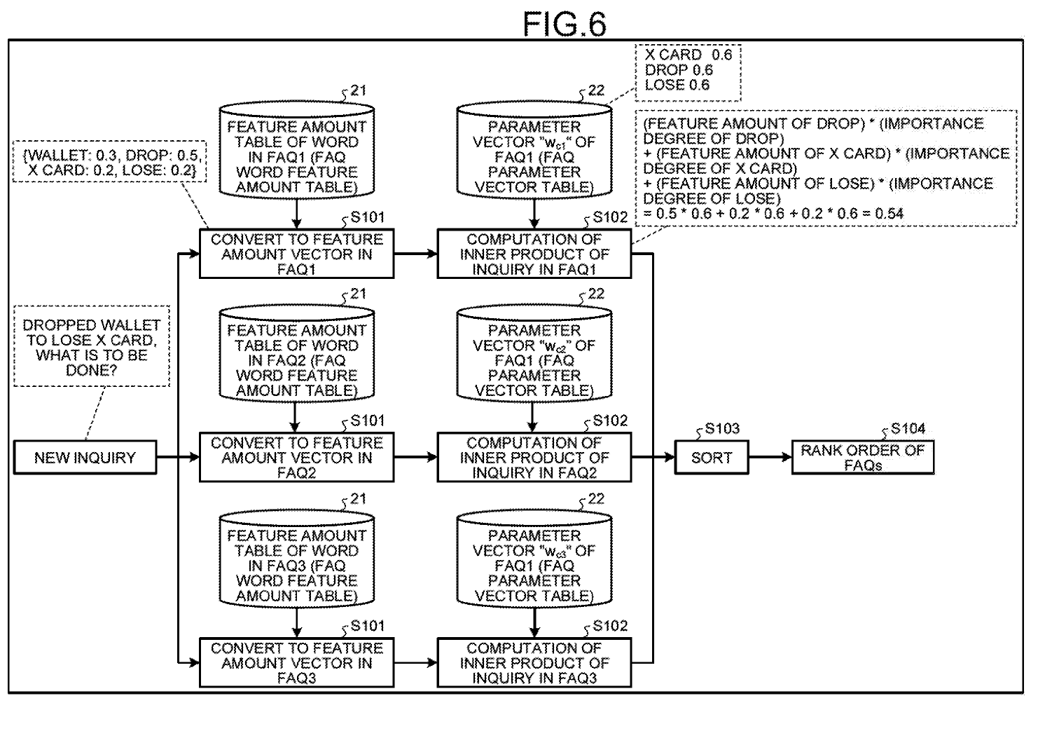

FIG. 6 is a diagram illustrating one example of the flow of a ranking outputting process according to the first embodiment. As illustrated in FIG. 6, the ranking outputting unit 14 inputs a new inquiry, and outputs a rank order of FAQs. Herein, a new inquiry is assumed to be “Dropped a wallet to lose an X card, what is to be done?”

The ranking outputting unit 14 executes word-division to convert the new inquiry to a word string. The ranking outputting unit 14 converts the word string of the new inquiry into a feature amount vector of each FAQ by using the feature amounts of words in the FAQ word feature amount table 21, which correspond to each FAQ (S101). Herein, as an example, the feature amount vector of the FAQ1 is assumed to be {wallet: 0.3, drop: 0.5, X card: 0.2, lose: 0.2, . . . }.

The ranking outputting unit 14 computes, for each FAQ, the inner products of the feature amount vectors and the parameter vectors (S102). Herein, as an example, the parameter vector of the FAQ1 is assumed to be {X card: 0.6, . . . , drop: 0.6, lose: 0.6, . . . }. The inner product of the feature amount vector of the FAQ1 and the parameter vector of the FAQ1 is computed to be “0.54”. Similarly, the ranking outputting unit 14 computes, for another FAQ, the inner product of the feature amount vector and the parameter vector (S101, S102).

The ranking outputting unit 14 sorts values of the inner products that are computed for each FAQ in descending order (S103), and ranks and outputs the FAQs (S104). Thereby, even in a case where the vocabulary of a new inquiry and the vocabulary of a FAQ do not accord with each other, the ranking outputting unit 14 can output appropriate FAQs for the new inquiry.

Flowchart of Information Processing

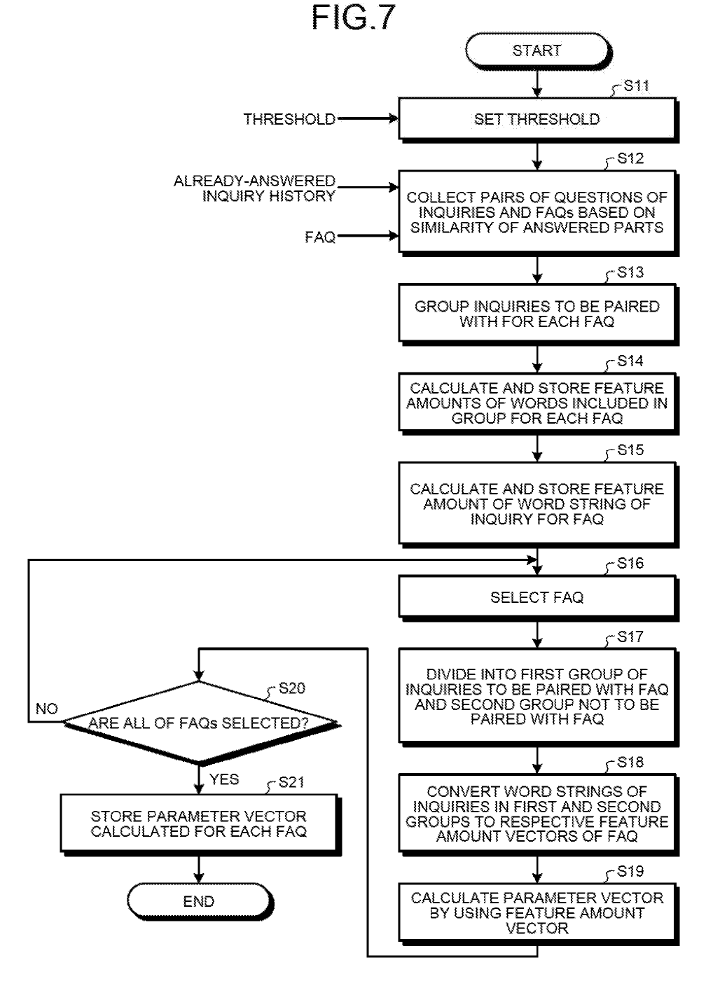

FIG. 7 is a flowchart illustrating one example of information processing according to the first embodiment.

As illustrated in FIG. 7, when receiving a threshold from a user, the threshold setting unit 11 sets the received threshold in the storage 20 (Step S11). The learning-data collecting unit 12 reads an already-answered inquiry history and FAQs from the storage 20, and collects pairs of questions of inquiries and FAQs on the basis of the similarity between the inquiries and answered parts of the FAQs (Step S12). For example, the learning-data collecting unit 12 computes the similarity between an answer of a FAQ and an answer of an inquiry. The learning-data collecting unit 12 collects pairs of the FAQs and the inquiries, which correspond to the answers of the FAQs and the answers of the inquiries whose similarity is the threshold or more.

Subsequently, the word feature-amount computing unit 131 groups, for each FAQ, the inquiries to be paired with a FAQ (Step S13). The word feature-amount computing unit 131 calculates, for each FAQ, the feature amount of a word included in the group, and stores the amount in the FAQ word feature amount table 21 (Step S14). For example, the word feature-amount computing unit 131 computes the appearance probabilities of words included in a set of inquiries to be paired with a FAQ by using the formula (6). The word feature-amount computing unit 131 computes the relative importance degrees (feature amounts) of the words in the FAQ by using the computed results and the formula (7).

Subsequently, the word string feature-amount computing unit 132 calculates, for each FAQ, the feature amount of the word string of the inquiry, and stores the amount in the FAQ word feature amount table 21 (Step S15). For example, the word string feature-amount computing unit 132 calculates the feature amount of the word string of the inquiry in each FAQ by using a word string extracted from an inquiry and the feature amounts of words of corresponding FAQ in the FAQ word feature amount table 21.

Subsequently, the vocabulary importance computing unit 133 selects a FAQ (Step S16). The vocabulary importance computing unit 133 divides the inquiries into the first group of the inquiries to be paired with the selected FAQ and the second group not to be paired with the selected FAQ (Step S17).

The vocabulary importance computing unit 133 converts the word strings of the inquiries in the first and second groups into the respective feature amount vectors of the selected FAQ (Step S18). For example, the vocabulary importance computing unit 133 converts a word string to be pared with the selected FAQ into a feature amount vector by using the feature amounts of words corresponding to the selected FAQ of the FAQ word feature amount table 21. The vocabulary importance computing unit 133 converts the selected word string not to be paired with the FAQ into the feature amount vector by using the feature amounts of the words corresponding to the selected FAQ of the FAQ word feature amount table 21. The vocabulary importance computing unit 133 adds the feature amount of the word string to the feature amount vector converted with respect to the word string.

The vocabulary importance computing unit 133 calculates the parameter vector by using the feature amount vector of the converted word string of the inquiry (Step S19). For example, the vocabulary importance computing unit 133 updates the parameter vector of the selected FAQ so that the weight of the feature amount that appears in the word string of the inquiry to be paired with the selected FAQ is large in the positive direction. The vocabulary importance computing unit 133 updates the parameter vector of the selected FAQ so that the weight of the feature amount that appears in the word string of the inquiry not to be paired with the selected FAQ is large in the negative direction.

The vocabulary importance computing unit 133 determines whether or not all of the FAQs are selected (Step S20). In a case where not all of the FAQs are determined to be selected (Step S20: No), the vocabulary importance computing unit 133 shifts to Step S16 to select a next FAQ.

On the other hand, in a case where all of the FAQs are determined to be selected (Step S20: Yes), the vocabulary importance computing unit 133 stores the parameter vector calculated for each FAQ in the FAQ parameter vector table 22 (Step S21), and the information processing is terminated.

### Effects of First Embodiment

According to the aforementioned first embodiment, the information processing apparatus 1 groups inquiries into resembling a past inquiry and inquiries not resembling the past inquiry, for each FAQ. The information processing apparatus 1 computes, for each FAQ, the feature amounts of respective words for the corresponding FAQ, which appear in the grouped resembling inquiries. The information processing apparatus 1 converts, for each FAQ, a word string extracted from the grouped resembling inquiries into a feature amount vector by using the feature amounts of respective words for the corresponding FAQ, and converts the word string extracted from the grouped non-resembling inquiries into a feature amount vector. The information processing apparatus 1 executes, for each FAQ, the following process on the basis of the feature amount vectors of the word strings extracted from the grouped resembling inquiries and the grouped non-resembling inquiries. In other words, the information processing apparatus 1 updates the parameter vector that indicates the importance degree of each word for a FAQ. By employing the configuration, the information processing apparatus 1 can output an appropriate FAQ for a new inquiry by using the parameter vector even in a case where words in the inquiry and words in the FAQ do not accord with each other.

According to the aforementioned first embodiment, the information processing apparatus 1 adds the feature amounts of the feature amount vector of the word string extracted from the grouped resembling inquiries to the respective same-position components in a parameter vector. The information processing apparatus 1 subtracts the feature amounts of the feature amount vector of the word string extracted from the grouped non-resembling inquiries from the respective same-position components in a parameter vector to update the parameter vector. By employing the configuration, the information processing apparatus 1 divides, caused by whether or not the inquiry resembles the FAQ, the feature amount vectors into the positive or the negative to update the parameter vector, and thus, the importance degree of a word among FAQs can be acquired.

According to the aforementioned first embodiment, the information processing apparatus 1 computes, for each FAQ, the feature amount of a word string extracted from the grouped resembling inquiries and that of a word string extracted from the grouped non-resembling inquiries. The information processing apparatus 1 adds the feature amounts of the word strings to respective feature amount vectors of the word strings extracted from the grouped resembling inquiries. The information processing apparatus 1 adds the feature amounts of the word strings to respective feature amount vectors of the word strings extracted from the grouped non-resembling inquiries. By employing the configuration, the information processing apparatus 1 divides, caused by whether or not the inquiry resembles the FAQ, the feature amount vectors into the positive or the negative to update the parameter vector, and thus, the importance degrees of words and word strings among FAQs, namely the vocabulary, can be acquired.

According to the aforementioned first embodiment, the information processing apparatus 1 converts a word string extracted from a new inquiry into a feature amount vector of each FAQ by using the feature amount of a word for the corresponding FAQ. The information processing apparatus 1 computes, for each FAQ, the inner product of the converted feature amount vector and a parameter vector. The information processing apparatus 1 outputs a ranking of FAQs on the basis of the values of the computed inner products. By employing the configuration, the information processing apparatus 1 can output an appropriate FAQ to a new inquiry even in a case where words of the new inquiry and words of the FAQ do not accord with each other.

### [b] Second Embodiment

Meanwhile, in the information processing apparatus 1 according to the first embodiment, for each FAQ, a word string extracted from an inquiry to be paired with the corresponding FAQ is converted into a feature amount vector, and a word string extracted from an inquiry not to be paired with the corresponding FAQ is converted into a feature amount vector. The information processing apparatus 1 generates a parameter vector of each FAQ on the basis of these feature amount vectors. However, the information processing apparatus 1 is not limited thereto, and may add the result that is calculated by using the parameter vector of each FAQ to a parameter vector of ranking leaning. Hereinafter, the parameter vector of the ranking leaning may be referred to as a “ranking parameter vector”.

In a second embodiment, the information processing apparatus 1 is not limit thereto, and a case in which the result that is calculated by using the parameter vector of each FAQ is added to the parameter vector of the ranking leaning will be explained.

### Configuration of Information Processing Apparatus According to Second Embodiment

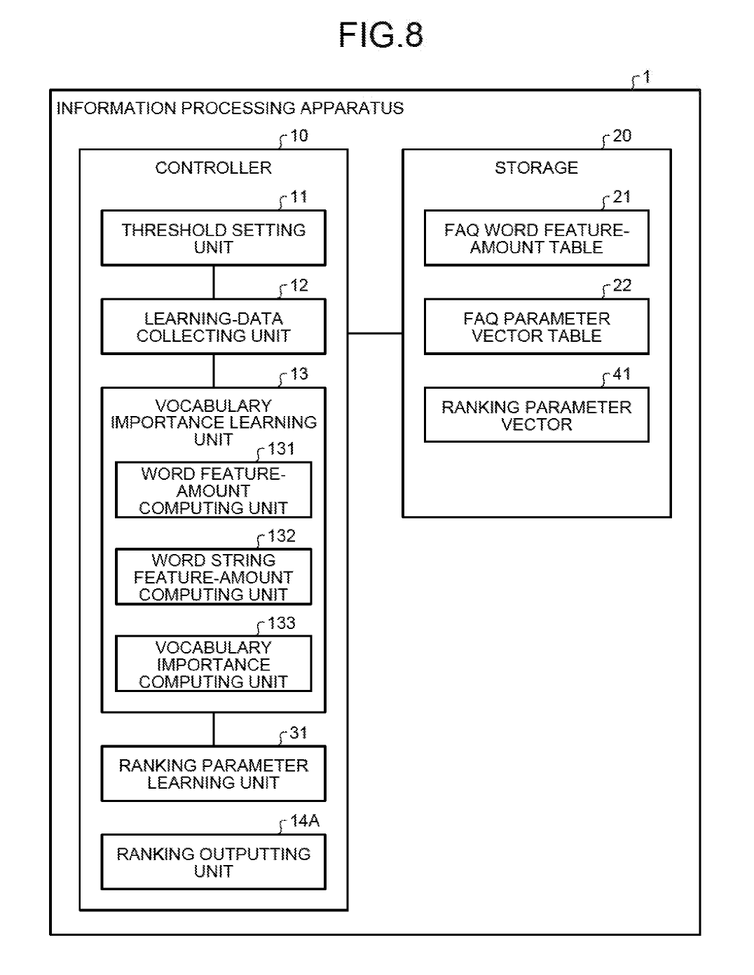

FIG. 8 is a functional block diagram illustrating a configuration of an information processing apparatus according to the second embodiment. The configuration similar to those of the information processing apparatus 1 illustrated in FIG. 1 will be provided with the same reference symbols to omit the duplicated explanation of the configuration and the operation thereof. The difference between the first and second embodiments includes points that a ranking parameter learning unit 31 and a ranking parameter vector 41 are added, and a ranking outputting unit 14A is modified.

The ranking parameter vector 41 indicates a parameter vector of the ranking. The ranking parameter vector 41 is generated by the ranking parameter learning unit 31, and is used by the ranking outputting unit 14A. The explanation of the ranking parameter vector 41 will be mentioned later.

The ranking parameter learning unit 31 learns a parameter of the ranking. The ranking parameter learning unit 31 stores the learned ranking parameter in the storage 20 as the ranking parameter vector 41.

For example, the ranking parameter learning unit 31 learns which FAQ is likely to be a correct answer for each of the inquiries that are collected by the learning-data collecting unit 12. Any existing technology may be used as the learning method.

The ranking parameter learning unit 31 generates, for each inquiry, a set of pairs of FAQs of correct answers and FAQs of incorrect answers, and updates the ranking parameter vector 41 so that the scores of the FAQs of the correct answers are larger than those of the FAQs of the incorrect answers for each of the pairs. In other words, the ranking parameter learning unit 31 updates the ranking parameter vector 41 to associate a FAQ of the correct answer with an inquiry. The score mentioned here is a “feature amount vector of ranking”. Herein, “ranking feature amount vector” is a vector in which the calculated result by using the parameter vector of each FAQ is added to the concordance rate of words between the inquiry and the asked part of the FAQ and that between the inquiry and the answered part of the FAQ. The explanation of the feature amount vector of the ranking will be mentioned later.

Outline of Ranking Parameter Learning Process

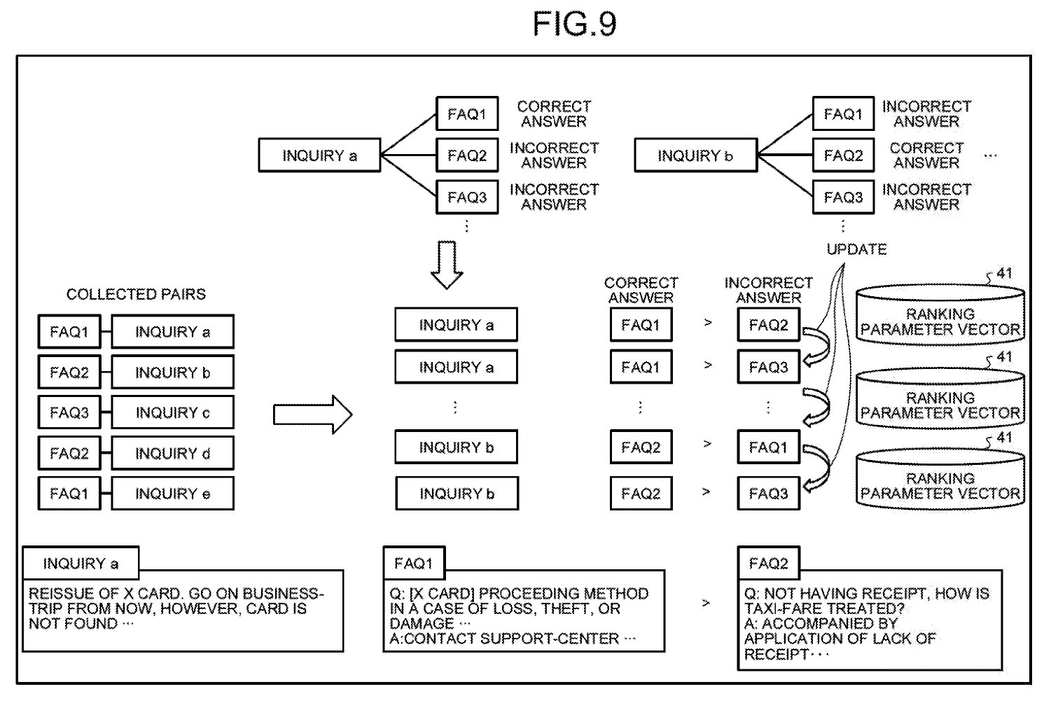

Herein, the outline of the ranking parameter learning process according to the second embodiment will be explained with reference to FIG. 9. FIG. 9 is a diagram illustrating the outline of the ranking parameter learning process according to the second embodiment.

As illustrated in FIG. 9, the ranking parameter learning unit 31 learns which FAQ is likely to be a correct answer for the inquiries that are collected by the learning-data collecting unit 12. Herein, whether or not the FAQ1 is likely to be a correct answer for the inquiry “a” is learned. Whether or not the FAQ2 is likely to be a correct answer for the inquiry “b” is learned.

The ranking parameter learning unit 31 generates, for each inquiry, a set of pairs of FAQs of correct answers and FAQs of incorrect answers. Herein, the pair of the inquiry “a” and the FAQ1 of a correct answer, the pair of the inquiry “a” and the FAQ2 of an incorrect answer, the pair of the inquiry “a” and the FAQ3 of an incorrect answer, etc. are generated. The pair of the inquiry “b” and the FAQ2 of a correct answer, the pair of the inquiry “b” and the FAQ1 of an incorrect answer, the pair of the inquiry “b” and the FAQ3 of an incorrect answer, etc. are generated.

The ranking parameter learning unit 31 updates the ranking parameter vector 41 so that the score of each FAQ of a correct answer is larger than the score of the corresponding FAQ of an incorrect answer. Herein, the ranking parameter learning unit 31 updates the ranking parameter vector 41 so that the score of the FAQ1 of a correct answer for the inquiry “a” is larger than the score of the FAQ2 of an incorrect answer. Moreover, the ranking parameter learning unit 31 updates the ranking parameter vector 41 so that the score of the FAQ1 of a correct answer for the inquiry “a” is larger than the score of another FAQ of an incorrect answer. Similarly, for the inquiry “b”, the inquiry “c”, etc., the ranking parameter learning unit 31 repeats the update of the ranking parameter vector 41 so that the score of the FAQ of a correct answer is larger than the score of the FAQ of an incorrect answer. The ranking parameter learning unit 31 stores the ranking parameter vector 41 that is the updated result in the storage 20.

Returning to FIG. 8, the ranking outputting unit 14A ranks and outputs, for a new inquiry, FAQs by using the score of each of the FAQs (feature amount vector of ranking) and the ranking parameter vector 41. For example, the ranking outputting unit 14A calculates, for a new inquiry, the score of each FAQ (feature amount vector of ranking). The ranking outputting unit 14A computes, for each FAQ, the inner product of the score and the ranking parameter vector 41. The value of the computed inner product is a value of the new inquiry that indicates the amount of characteristics of the FAQ. The ranking outputting unit 14A sorts values of the computed inner products in descending order, and ranks and outputs the FAQs.

Flow of Ranking Parameter Learning Process

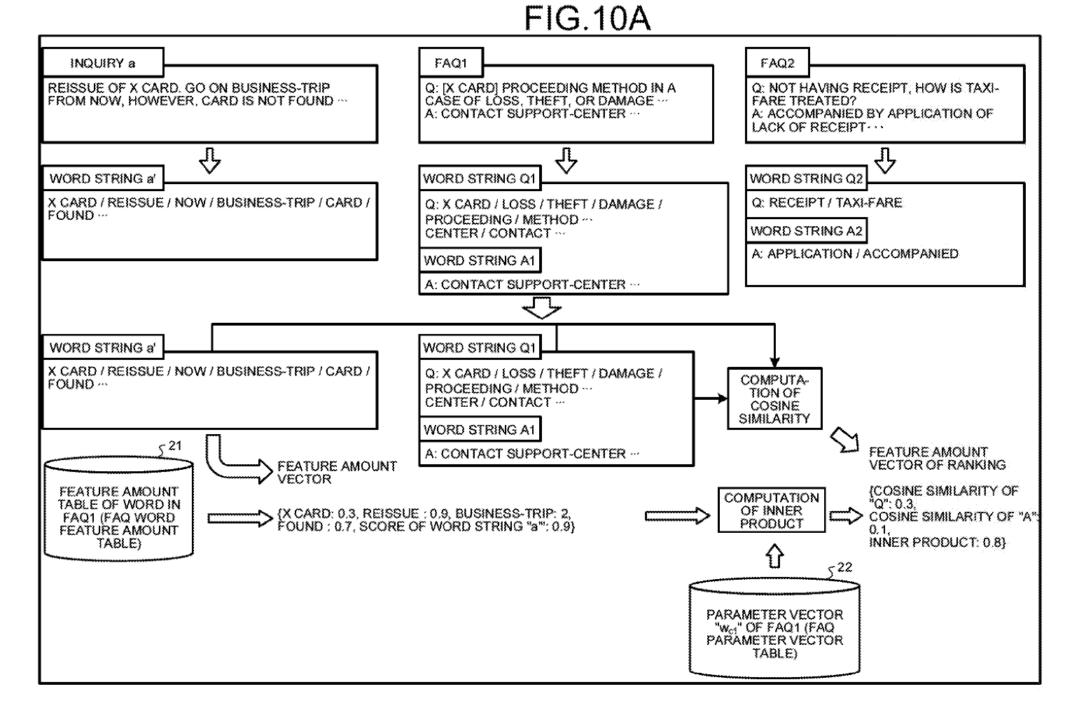

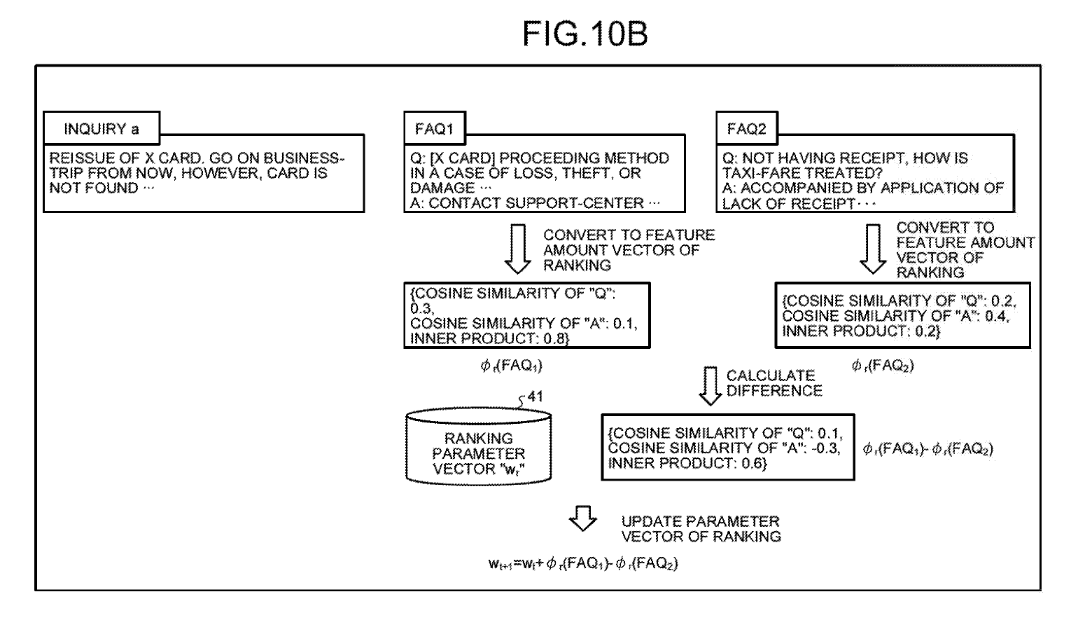

FIGS. 10A and 10B are diagrams illustrating examples of the flow of a ranking parameter learning process according to the second embodiment. The ranking parameter learning unit 31 is assumed to generate, for each inquiry, the set of the pairs of FAQs of correct answers and FAQs of incorrect answers.

As illustrated in FIG. 10A, the ranking parameter learning unit 31 converts an inquiry, an asked part of a FAQ, and an answered part of a FAQ to respective word strings for each pair of the inquiry and the FAQ. Herein, the inquiry “a” is converted into a word string. The asked part (part “Q”) and the answered part (part “A”) of the FAQ1 are converted to word strings, respectively. The asked part (part “Q”) and the answered part (part “A”) of the FAQ2 are converted into word strings, respectively.

The ranking parameter learning unit 31 converts the FAQs for the inquiry into respective scores (feature amount vectors of ranking). Herein, as an example, a case in which the FAQ1 for the inquiry “a” is converted to the score (feature amount vector of ranking) will be explained.

First, the ranking parameter learning unit 31 converts the inquiry “a” to the feature amount vector in the FAQ1 by using the FAQ word feature amount table 21. The converting method is similar to the method executed by the vocabulary importance computing unit 133. Herein, the word string “a′” of the inquiry “a” is “X card, reissue, now, business-trip, card, found”. The feature amount vector in the FAQ1 is assumed to be {X card: 0.3, reissue: 0.9, business-trip: 2, found: 0.7, . . . , score for word string “a′”: 0.9}.

Next, the ranking parameter learning unit 31 computes the concordance rate of words between the inquiry “a” and the asked part of the FAQ1. The computed result is the first component of the score (feature amount vector of ranking). The ranking parameter learning unit 31 computes the concordance rate of words between the inquiry “a” and the answered part of the FAQ1. The computed result is the second component of the score (feature amount vector of ranking). As an example, the ranking parameter learning unit 31 computes the cosine similarity between the word string “a′” of the inquiry “a” and a word string “Q1” of the asked part of the FAQ1. The ranking parameter learning unit 31 computes the cosine similarity between the word string “a′” of the inquiry “a” and the word string “A1” of the answered part of the FAQ1. Herein, the cosine similarity of the word string “Q1” (cosine similarity of “Q”) is assumed to be “0.3”. The cosine similarity of the word string “A1” (cosine similarity of “A”) is assumed to be “0.1”.

Next, the ranking parameter learning unit 31 computes the inner product of the feature amount vector of the inquiry “a” in the FAQ1 and the parameter vector of the FAQ1. The computed result is the third component of the score (feature amount vector of ranking). The computed value of the inner product may be the value that indicates the amount of characteristics of the FAQ1 included in the inquiry “a”. The parameter vector of the FAQ1 is stored in the FAQ parameter vector table 22. Herein, the value of the inner product is assumed to be “0.8”.

As a result, the ranking parameter learning unit 31 acquires the score (feature amount vector of ranking) of the FAQ1 for the inquiry “a”. Herein, the score (feature amount vector of ranking) is “0.3” as the cosine similarity of “Q”, “0.1” as the cosine similarity of “A”, and “0.8” as the inner product.

Similarly, the ranking parameter learning unit 31 converts the FAQ for the inquiry into the score (feature amount vector of ranking) with respect to the pair including a FAQ of a correct answer and the pair including a FAQ of an incorrect answer, which are generated for each inquiry.

As illustrated in FIG. 10B, the ranking parameter learning unit 31 calculates the difference between the scores of two FAQs for the inquiry, and updates the ranking parameter vector 41 so that the score of the FAQ of a correct answer is larger than the score of the FAQ of an incorrect answer. Herein, as an example, a case in which the ranking parameter learning unit 31 updates the ranking parameter vector 41 by using the two scores of the FAQ1 and the FAQ2 for the inquiry “a” will be explained. The FAQ1 is assumed to be a correct answer for the inquiry “a”. The FAQ2 is assumed to be an incorrect answer for the inquiry “a”.

First, the ranking parameter learning unit 31 calculates the difference so that a feature amount vector “φr(FAQ₁)” of the ranking of the FAQ1 of a correct answer for the inquiry “a” is larger than a feature amount vector “φr(FAQ₂)” of the ranking of the FAQ2 of an incorrect answer. Herein, “φr(FAQ₁)” is assumed to be {cosine similarity of “Q”: 0.3, cosine similarity of “A”: 0.1, inner product: 0.8}, and “φr(FAQ₂)” is assumed to be {cosine similarity of “Q”: 0.2, cosine similarity of “A”: 0.4, inner product: 0.2}. The difference produced by subtraction of “φr(FAQ₂)” from “φr(FAQ₁)” is computed as {cosine similarity of “Q”: 0.1, cosine similarity of “A”: −0.3, inner product: 0.6}.

Next, the ranking parameter learning unit 31 adds the calculated difference to the ranking parameter vector 41 to update the ranking parameter vector 41.

Similarly, the ranking parameter learning unit 31 continues updating the ranking parameter vector 41 so that the score of the FAQ1 of a correct answer for the inquiry “a” is larger than that of another FAQ of an incorrect answer for the inquiry “a”. The ranking parameter learning unit 31 continues updating the ranking parameter vector 41 so that the score of the FAQ of a correct answer for another inquiry is larger than the score of the FAQ of an incorrect answer for the another inquiry. The ranking parameter learning unit 31 acquires the ranking parameter vector 41. In other words, the ranking parameter learning unit 31 updates, regarding as an important feature to be associated with the FAQ of a correct answer, the weight of the feature amount more widely in the positive direction as the difference of the feature amounts is larger in the positive, and updates the weight of the feature amount more widely in the negative direction as the difference of the feature amounts is larger in the negative.

Thereby, the ranking parameter learning unit 31 adds the inner product calculated by using the parameter vector of each FAQ to the ranking parameter vector 41, and thus, the FAQ of a correct answer can be ranked to the high order even in a case where words of the inquiry and words of the FAQ of a correct answer do not accord with each other. In other words, the ranking parameter learning unit 31 uses the result that is calculated by using the importance degree of the vocabulary of each FAQ in addition to the feature amount of the ranking leaning, and thus, the accuracy of the ranking of the FAQs can be improved. Moreover, even in a case where a FAQ exists, whose learning data does not exist and characteristics thereof is not expressed by the inner product, the ranking parameter learning unit 31 can rank FAQs by using another feature amount (feature amount of ranking leaning).

Flow of Ranking Outputting Process

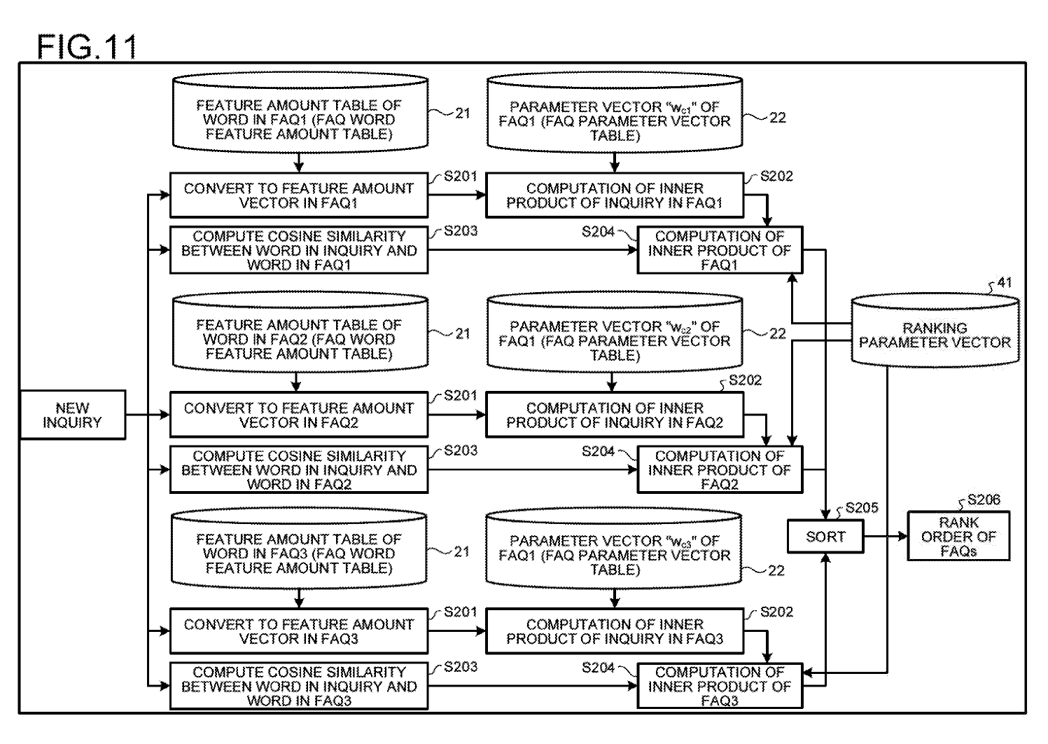

FIG. 11 is a diagram illustrating one example of the flow of ranking outputting process according to the second embodiment. As illustrated in FIG. 11, the ranking outputting unit 14A inputs a new inquiry and outputs a rank order of FAQs.

The ranking outputting unit 14A executes word-division to a new inquiry to convert to a word string. The ranking outputting unit 14A converts the word string of the new inquiry to a feature amount vector of each FAQ by using the feature amounts of the words of corresponding FAQ in the FAQ word feature amount table 21 (S201). The ranking outputting unit 14A computes, for each FAQ, the inner product of the converted feature amount vector and the parameter vector (S202).

The ranking outputting unit 14A calculates the cosine similarity between the word string of the new inquiry and the word string of the asked part of the FAQ1, and that between the word string of the new inquiry and the word string of the answered part of the FAQ1 (S203). The ranking outputting unit 14A converts the FAQ1 to the score (feature amount vector of ranking). In other words, the ranking outputting unit 14A sets the cosine similarity calculated in S203 of the asked part of the FAQ1, the cosine similarity calculated in S203 of the answered part of the FAQ1, and the inner product calculated in S202 as the scores of the FAQ1.

The ranking outputting unit 14A calculates the inner product of the feature amount vector of the ranking of the FAQ1 and the ranking parameter vector 41 (S204).

Similarly, the ranking outputting unit 14A further calculates the inner product of the feature amount vector of the ranking of the FAQ and the ranking parameter vector 41 for another FAQ (S201 to S204).

The ranking outputting unit 14A sorts the values of the inner products that are computed for respective FAQs in descending order (S205), and ranks and outputs the FAQs (S206). Thereby, the ranking outputting unit 14A can output the appropriate FAQ to a new inquiry even in a case where the vocabulary of a new inquiry and the vocabulary of the FAQ do not accord with each other.

Flowchart of Information Processing

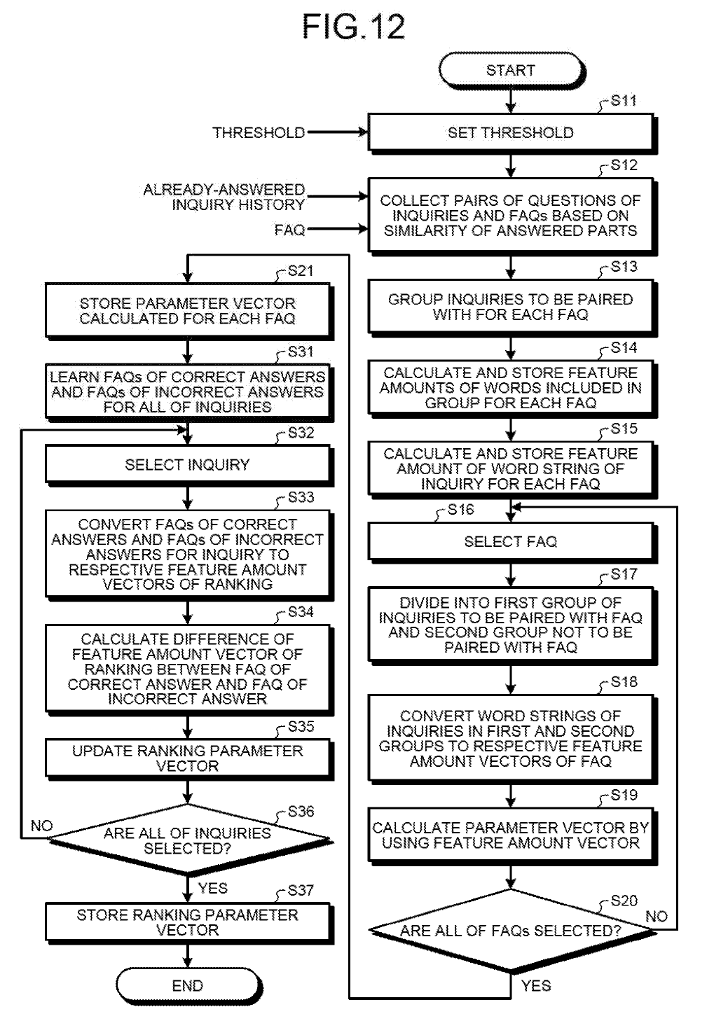

FIG. 12 is a flowchart illustrating one example of information processing according to the second embodiment. Steps S11 to S21 of the information processing according to the second embodiment are similar to those in the flowchart of the information processing according to the first embodiment, and thus, will be simplified in the following explanation.

As illustrated in FIG. 12, when receiving a threshold from a user, the threshold setting unit 11 sets the received threshold in the storage 20 (Step S11). The learning-data collecting unit 12 reads an already-answered inquiry history and FAQs from the storage 20, and collects pairs of questions of inquiries and FAQs on the basis of the similarity between the inquiries and the answered parts of the FAQs (Step S12).

Subsequently, the word feature-amount computing unit 131 groups, for each FAQ, the inquiries to be paired with the corresponding FAQ (Step S13). The word feature-amount computing unit 131 calculates, for each FAQ, the feature amounts of the words included in the group, and stores the amounts in the FAQ word feature amount table 21 (Step S14).

Subsequently, the word string feature-amount computing unit 132 calculates, for each FAQ, the feature amount of the word string of the inquiry, and stores the amount in the FAQ word feature amount table 21 (Step S15). For example, the word string feature-amount computing unit 132 calculates the feature amount of the word string of the inquiry in each FAQ by using the word string extracted from the inquiry and the feature amounts of words of the corresponding FAQ in the FAQ word feature amount table 21.

Subsequently, the vocabulary importance computing unit 133 selects the FAQs (Step S16) to divide into the first group of the inquiries to be paired with the selected FAQs and the second group not to be paired with the selected FAQs (Step S17).

The vocabulary importance computing unit 133 converts the word strings of the inquiries in the first and second groups to the respective feature amount vectors of the selected FAQs (Step S18). The vocabulary importance computing unit 133 calculates the parameter vector by using the feature amount vector of the converted word string of the inquiry (Step S19).

The vocabulary importance computing unit 133 determines whether or not all of the FAQs are selected (Step S20). In a case where not all of the FAQs are determined to be selected (Step S20: No), the vocabulary importance computing unit 133 shifts to Step S16 to select a next FAQ.

On the other hand, in a case where all of the FAQs are determined to be selected (Step S20: Yes), the vocabulary importance computing unit 133 stores the parameter vector calculated for each FAQ in the FAQ parameter vector table 22 (Step S21).

The ranking parameter learning unit 31 learns FAQs of correct answers and FAQs of incorrect answers for all of the inquiries (Step S31).

Subsequently, the ranking parameter learning unit 31 selects the inquiry (Step S32).

The ranking parameter learning unit 31 converts the FAQs of the correct answers and the FAQs of the incorrect answers for the selected inquiry to the respective feature amount vectors of ranking (Step S33). For example, the ranking parameter learning unit 31 converts the selected inquiry to the feature amount vector of the FAQ of a correct answer from the FAQ word feature amount table 21. The ranking parameter learning unit 31 computes the concordance rate (cosine similarity) of words between the selected inquiry and the asked part of the FAQ of a correct answer. The ranking parameter leaning unit 31 computes the concordance rate (cosine similarity) of words between the selected inquiry and the answered part of the FAQ of the correct answer. The ranking parameter learning unit 31 computes the inner product of the feature amount vector of the FAQ of a correct answer in the selected inquiry and the parameter vector of the FAQ of a correct answer. As a result, the ranking parameter learning unit 31 acquires the feature amount vector of ranking for the FAQ of a correct answer for the selected inquiry. The ranking parameter learning unit 31 similarly acquires the feature amount vector of ranking of the FAQ for the selected inquiry with respect to the FAQ of an incorrect answer.

The ranking parameter learning unit 31 calculates the difference of the feature amount vector of the ranking between the FAQ of a correct answer and the FAQ of an incorrect answer (Step S34). The ranking parameter learning unit 31 updates the ranking parameter vector 41 so that the feature amount vector in the ranking of the FAQ of a correct answer is larger than that of an incorrect answer (Step S35).

The ranking parameter learning unit 31 determines whether or not all of the inquiries are selected (Step S36). In a case where not all of the inquiries are determined to be selected (Step S36: No), the ranking parameter learning unit 31 shifts to Step S32 to select a next inquiry.

On the other hand, in a case where all of the inquiries are determined to be selected (Step S36: Yes), the ranking parameter learning unit 31 stores the ranking parameter vector 41 in the storage 20 (Step S37), and the information processing is terminated.

### Effects of Second Embodiment

According to the aforementioned second embodiment, the information processing apparatus 1 adds the result that is calculated by using the parameter vector in each FAQ to the ranking parameter vector 41 of the ranking leaning. By employing the configuration, the information processing apparatus 1 can output the FAQ of a correct answer to be ranked to the high order even in a case where words of a new inquiry and words of the FAQ of a correct answer do not accord with each other.

Others

In addition, each component of the information processing apparatus 1 illustrated in the drawings is functionally conceptual, and thus, does not always physically configured as illustrated in the drawings. Namely, a specific mode of separation or integration of the information processing apparatus 1 is not limited to that illustrated in the drawings. That is, all or some of the components can be configured by separating or integrating them functionally or physically in any unit, according to various types of loads, the status of use, etc. For example, the word feature-amount computing unit 131 and the word string feature-amount computing unit 132 may be integrated as one unit. The storage 20 may be connected via a network being as an external device of the information processing apparatus 1.

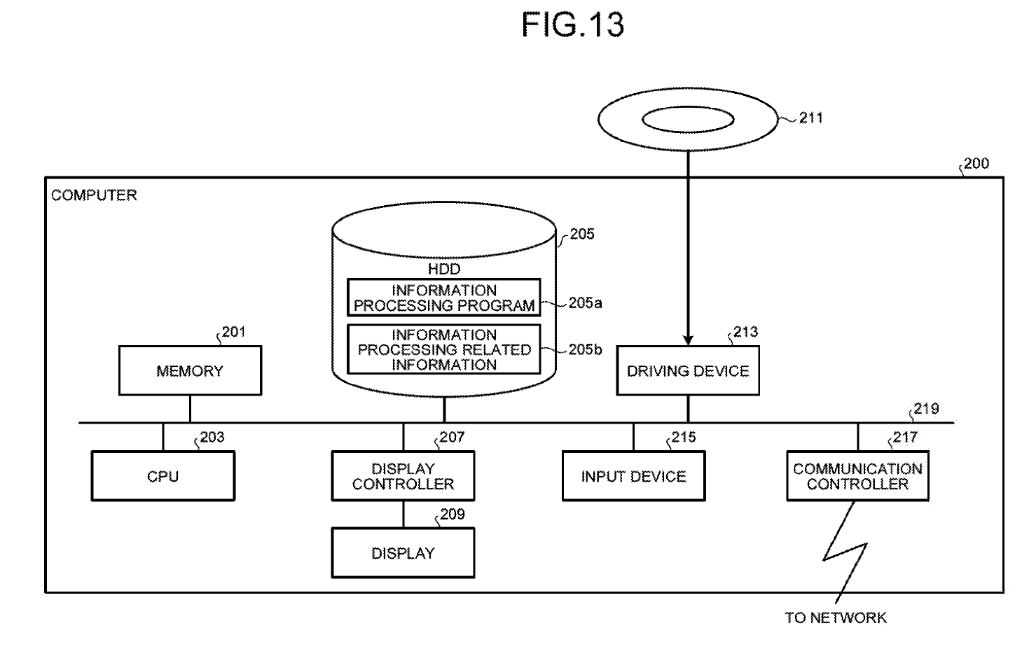

A computer such as a personal computer and a workstation may execute a preliminarily prepared program, and thus, various processes having explained in the aforementioned embodiments can be realized. Hereinafter, one example of a computer will be explained, which executes an information processing program that realizes functions similar to those of the information processing apparatus 1 illustrated in FIG. 1. FIG. 13 is a diagram illustrating one example of a computer that executes an information processing program.

As illustrated in FIG. 13, a computer 200 includes a CPU 203 that executes various calculation processes, an input device 215 that receives input of data from a user, and a display controller 207 that controls a display 209. The computer 200 includes a driving device 213 that reads a program and the like from a storing medium and a communication controller 217 that inputs/outputs data from/to another computer via a network. The computer 200 includes a memory 201 that temporarily stores various kinds of information and a Hard Disk Drive (HDD) 205. The memory 201, the CPU 203, the HDD 205, the display controller 207, the driving device 213, the input device 215, and the communication controller 217 are connected to one another via a bus 219.

The driving device 213 is a device for, for example, a removable disk 211. The HDD 205 stores an information processing program 205a and information processing related information 205b.

The CPU 203 reads the information processing program 205a to expand in the memory 201, and executes the program as a process. The process corresponds to each of the functions of the information processing apparatus 1. The information processing related information 205b corresponds to the FAQ word feature amount table 21 and the FAQ parameter vector table 22. For example, the removable disk 211 stores various kinds of information in the information processing program 205a and the like.

The information processing program 205a is not needed to be preliminarily stored in the HDD 205. For example, the program may be preliminarily stored in “portable physical medium” such as a Flexible Disk (FD), a Compact Disk-Read Only Memory (CD-ROM), a Digital Versatile Disc (DVD), a magneto-optical disk, and an Integrated Circuit card (IC card), which are to be inserted into the computer 200, and the computer 200 may read and execute the information processing program 205a therefrom.

According to an aspect of the embodiments, an already-answered question for a newly-input question can be appropriately ranked, even in a case where words between the newly-input question and the already-answered question do not accord with each other.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer to execute a process, the process comprising:
grouping a plurality of inquiry items into a resembling inquiry item group and a non-resembling inquiry item group;
computing feature amounts of words that appear in the resembling inquiry item group;
converting, by using the feature amounts of words, a first word string to be extracted from the resembling inquiry item group into a first feature amount vector and a second word string to be extracted from the non-resembling inquiry item group into a second feature amount vector; and
updating a parameter vector that indicates importance degrees of the words based on the first and second feature amount vectors.

2. The non-transitory computer-readable recording medium according to claim 1, wherein the updating includes adding each feature amount included in the first feature amount vector of the first word string to the parameter vector and subtracting each feature amount included in the second feature amount vector of the second word string from the parameter vector to update the parameter vector.

3. The non-transitory computer-readable recording medium according to claim 1, the process further including
computing feature amounts of the first and second word strings, wherein
the converting includes adding the feature amount of the first word string to the first feature amount vector of the first word string and adding the feature amount of the second word string to the second feature amount vector of the second word string.

4. The non-transitory computer-readable recording medium according to claim 1, the process further including:
converting a word string extracted from a new inquiry into a feature amount vector of each Frequently Asked Question (FAQ) by using feature amounts of words of the FAQs;
computing inner products of the converted feature amount vectors and the parameter vectors for the FAQs; and
outputting a rank order of the FAQs based on values of the computed inner products.

5. The non-transitory computer-readable recording medium according to claim 1, further comprising adding a result calculated by using the parameter vector to a parameter vector of ranking leaning.

6. An information processing apparatus comprising:
a processor, wherein the processor executes:
grouping a plurality of inquiry items into a resembling inquiry item group and a non-resembling inquiry item group;
computing feature amounts of words that appear in the resembling inquiry item group;
converting, by using the feature amounts of words, a first word string to be extracted from the resembling inquiry item group into a first feature amount vector, and converting a second word string to be extracted from the non-resembling inquiry item group into a second feature amount vector by using the feature amount; and
updating a parameter vector that indicates importance degrees of the words based on the first and second feature amount vectors.

7. An information processing method implemented by a computer, the method comprising:
grouping a plurality of inquiry items into a resembling inquiry item group and a non-resembling inquiry item group using a processor;
computing a feature amount of each word that appears in the resembling inquiry item group using the processor;
converting, by using the feature amount of words, a first word string to be extracted from the resembling inquiry item group into a first feature amount vector and converting a second word string to be extracted from the non-resembling inquiry item group into a second feature amount vector using the processor; and
updating a parameter vector that indicates importance degrees of the words based on the first and second feature amount vectors using the processor.
